(19) United States
(12) Patent Application Publication
(10) Pub. No.: US 2001/0024446 A1
(43) Pub. Date: Sep. 27, 2001

(54) System and method for adaptive, slot-mapping input/output queuing for TDM/TDMA systems

(76) Inventors: Robert George Alexander Craig, Orleans (CA); Aneesh Dalvi, Greely (CA); Marc Levesque, Hull (CA)

Correspondence Address: BORDEN LADNER GERVAIS, LLP, 1000 - 60 QUEEN STREET, OTTAWA, ON, K1P 5Y7, CA

(21) Appl. No.: 09/812,832

(22) Filed: Mar. 21, 2001

(30) Foreign Application Priority Data
Mar. 21, 2000 (CA) 2,301,973

(51) Int. Cl. H04J 3/14; H04L 12/26; H04L 12/28; H04L 12/56

(52) U.S. Cl. 370/412; 370/222

(57) ABSTRACT

An input/output data queuing apparatus and method for data transfer between a control processor and a time division multiplex modem is disclosed. A plurality of queues within the modem is accessed through a queue selection block controlled by a timing control block that is in turn controlled via software. This allows directed multiplexing of specific data types into specific TDM transmission slots and retrieval and de-multiplexing of specific data types from the received TDM data stream. A plurality of processor queues feeds each queue allowing prioritisation of the transmitted data elements. This eases processor requirements, maximises the use of the available transmission slots and provides an access mechanism that is adaptable to a wide range of systems.

### FIELD OF THE INVENTION

The present invention relates to transferring data to and from time division multiplexing modems and is particularly concerned with easing the processor timing requirements within a control processor while ensuring correct mapping into and retrieval of data from a slotted physical layer.

### BACKGROUND OF THE INVENTION

An important element required for accessing a time division multiplexing (TDM)/time division multiple access (TDMA) stream is the method whereby data is transferred in and out of the modem. Given a system implementation in which a specific functionality or data type is attributed to individual slots within the TDM scheme (for example, a broadband TDMA modem with traffic slots and signalling slots) this requires specific data from the control processor to be mapped into the appropriate TDM slots in the physical layer.

For transmission, implementations in which both the data prioritisation and mapping to slots are carried out in the control processor are difficult. Either they establish a queuing order some time in advance of transmission or they require fine scale knowledge of the timing state of the modem in order to ensure that data is sent to the modem appropriately. If an advanced queuing order is established, lost transmit opportunities may result if data is received after the queuing order has been implemented. If fine scale knowledge of the timing state of the modulator is required, this increases the complexity of the processor interface and the software implementation in the control processor.

Systems relating to the field of the present invention are known, for example, U.S. Pat. No. 4,355,388 by Deal issued Oct. 19, 1982; U.S. Pat. No. 5,926,458 by Yin issued Jul. 20, 1999; and U.S. Pat. No. 3,818,453 by Schmidt et. al., issued Jun. 18, 1974.

An example of multiple queue servicing is shown in Yin et. al., however, it is concerned only with transmission of data packets from queues. The packet scheduler of the prior art uses bandwidth and packet size information to determine queue service times. No TDM access scheme is implied by the prior art invention. The mechanism whereby elements from specific queues are placed in specific slots is therefore not indicated.

Another problem with some systems is that queues are never serviced when there is no data to transmit. In that case, queue underflow can result in an undesirable delay in processor queue selection. Alternatively, requiring the processor to generate idle queue data unnecessarily increases the processing by the processor.

In prior art implementations of a micro-programmable TDMA terminal controller, signaling and burst data are combined together to form a data burst which remains constant in size and format with time. Individual shift registers are used to multiplex or de-multiplex the data and signalling information in RAM into a single data element for transmission on /reception from a particular slot. No queuing capability is suggested by the prior art.

In many existing systems, all bursts contain the same data type, therefore there is no need to map particular data types into particular slots. In addition no programmability is required to allow different slot widths and formats.

Accordingly, the prior art is incapable or ill adapted to processing data streams having different data formats.

It is therefore desirable to provide a queuing apparatus and process that overcomes or mitigates the problems of the prior art.

### SUMMARY OF THE INVENTION

Accordingly, it is an object of this invention to provide an improved process that ensures timely availability of correctly formatted data for multiplexing into individual transmit time slots, and allows de-multiplexing of the received time slots into separate data paths.

It is a further object of this invention to provide a programmable capability that allows the invention to be utilised within a variety of different systems.

A higher level hierarchical queuing exists consisting of processor queues and modem queues. Prioritisation is carried out in the processor queues and slot mapping is carried out in the modem queues. The present invention applies to both transmission and reception of data.

Software dictates which data from a queue or combination of queues goes into which slot by controlling the (hardware) queue server using a (software) slot processor. This is traditionally done under hardware control. The separation of data prioritisation (done in software) from slot mapping requirements (done in hardware under software control) eases processor software requirements. In addition, the size of modem queues required within the modem is reduced and the present invention is adaptable to a variety of wireless TDM(A) system specifications.

The modem queue server can be programmed to combine data from a plurality of modem queues into one data packet for transmission whereas the prior art queue server transmits data from a single queue at a time. Data from separate queues can be combined to fill a single slot, where traditionally single, fixed size queue fills a single slot. The data combined from the different queues need not have the same format.

The present invention's timing controller uses information contained within a burst time plan as passed to it from a master server system element. Variable length slot sizes are supported. This approach allows: directed multiplexing of particular data elements into specific transmission slots; data elements from more than one queue to be combined and transmitted as one data element; and a single received data element to be decomposed into more than one data element, each data element then being placed in a separate receive queue.

An accordance with an aspect of the present invention there is provided a system for queuing data for transmission by a modem having first queues for queuing received data from a plurality of data streams and at least one queue selection entity for selecting data from the first queues. Second queues queue data from the at least one queue selection entity and a queue server assembles data from the second queues for transmission by the modem.

According to another aspect of the present invention, there is provided a system for queuing data received by a modem having a queue server for disassembling data received by the modem, a plurality of first queues for queuing the disassembled data and a plurality of second queues. There is also at least one queue selection entity for receiving data from the first queues and queuing the data to the second queues.

According to a further aspect of the present invention there is provided a method of queuing data for transmission by a modem comprising: selecting data from each of a plurality of group of first queues; queuing the selected data into a plurality of second queues; selecting data from the data queued in the second queues; and assembling the selected data element from the second queues for transmission by the modem.

According to a still further aspect of the present invention, there is provided a method of queuing data received in a modem comprising: disassembling the received data; queuing the disassembled data to a plurality of first queues; retrieving data from the plurality of first queues; and queuing the retrieved data to a plurality of groups of second queues.

In an alternative embodiment, queues may be serviced and produce idle data when no data is ready to be transmitted and configurable idle data can be generated for each queue.

An advantage of the present invention is that data streams having different data formats can be handled. The system of the present invention can support variable length slot sizes and the system is programmable to meet any sort of slot requirement. A further advantage of the present invention is that the modem queue can be reduced.

Further features of the present invention will be apparent from the ensuing description with reference to the accompanying diagrams to which, however, the scope of the invention is in no way limited.

### BRIEF DESCRIPTION OF THE DRAWINGS

Preferred embodiments of the present invention will now be described, by way of example only, with reference to the attached Figures, wherein:

FIG. 1 illustrates, in a block diagram, the input queuing for transmit data in accordance with an embodiment of the present invention;

FIG. 2 illustrates, in a block diagram, the output queuing for receive data in accordance with an embodiment of the present invention;

FIG. 3 illustrates an example of a slotted access scheme;

FIG. 4 illustrates an exemplary system that uses the disclosed invention;

FIG. 5 illustrates a specific example of how data is processed by an embodiment of the invention;

FIG. 6 illustrates a burst time plan for the example of FIG. 5 and associated time slots; and

FIG. 7 illustrates an alternative embodiment of the present invention.

### DETAILED DESCRIPTION OF THE INVENTION

The present invention relates to an input/output data queuing apparatus and method for data transfer between a control processor and a time division multiplexing modem. A plurality of (modem) queues within the modem is accessed through a modem queue server that includes a software controlled timing control block. This allows directed multiplexing of different data types into specific TDM transmission slots and retrieval and de-multiplexing of different data types from the received TDM data stream.

On the transmit side, a plurality of processor queues feeds each modem queue allowing prioritisation of the transmitted data elements. This eases processor requirements, maximises the use of the available transmission slots and provides an access mechanism that is adaptable to a wide range of systems.

The input queuing data transfer mechanism used in this implementation provides separate transmit queues in the processor for different data types (or, equivalently, transmission slot types). By using a queue server and a high-resolution timing controller within the TDM modulator sub-system, correct mapping of the queued information into the specified slots is achieved. This includes the capability of combining data from several queues into a single data element for transmission on a specific slot. The use of multiple processor queues to feed a single modem queue allows data of the same type to be correctly prioritised before it is fed into the modulator. Thus quality of service and combining data into elements for transmission occur at different layers. Quality of service is handled in the control processor while slot mapping is handled in the modem.

On the receive path, a mechanism is provided for separating the received data slots in such a manner that slots of the same functional group/data type can be handled in a similar manner. While this can be carried out using separate carriers and demodulators, providing this capability in a single demodulator reduces cost (since fewer modems are required) and can reduce bandwidth inefficiencies (since fewer carriers are required). The output queuing data transfer mechanism used in this implementation provides separate modem receive queues for each data type. By using a programmable queue selection engine and a high-resolution timing controller within the TDM demodulator sub-system, the contents of specific data slots can be broken apart (if required) and placed in specific modem output queues. The data in the modem queues is retrieved by the control processor through the processor interface, examined by the processor queue selection entity and passed onto one or more processor queues for access by a higher layer application.

According to an embodiment of the present invention, a time division multiple access data transfer apparatus transmits data in specified time slots in a time division multiplexed transmit stream and separates data from a received time division multiplexed stream. The apparatus includes a microprocessor within which software elements operate, a modem within which hardware elements operate and a plurality of processor queues implemented in software into or from which data flows. A plurality of processor queue selection elements is operatively connected to the processor queues and a plurality of modem queues is provided wherein each said modem queue is operatively connected to one of the processor queue selection elements. A programmable modem queue server is operatively connected to all of the modem queues. A slot processor is operatively connected to the programmable modem queue server.

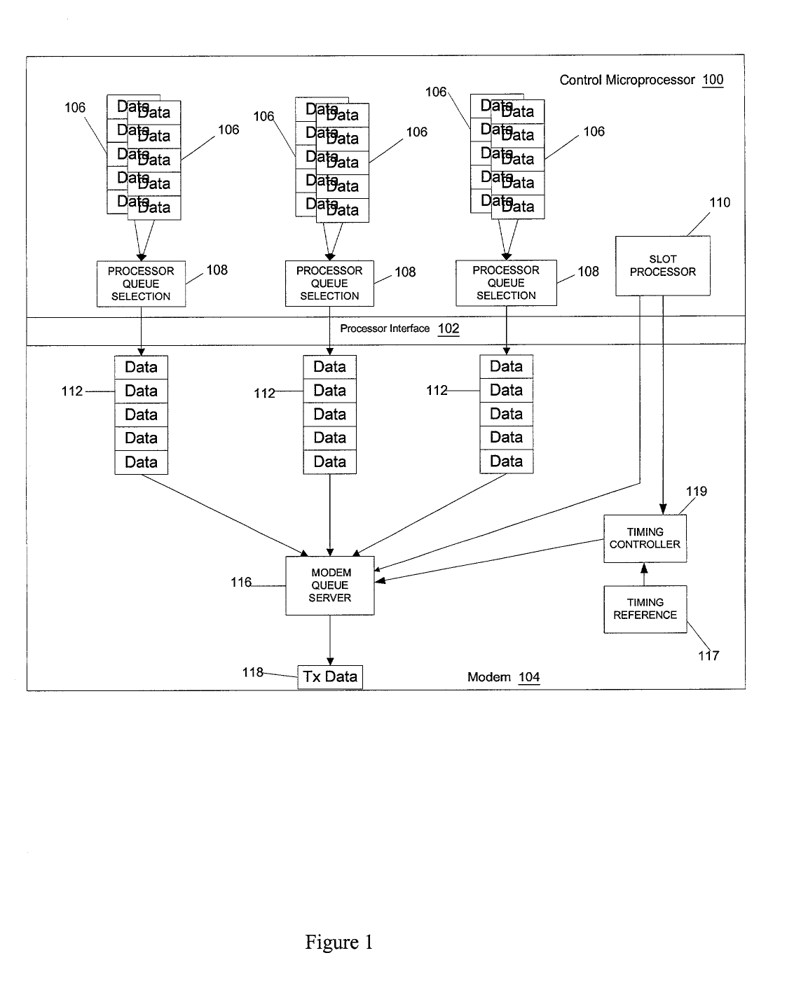

More specifically, referring to FIG. 1, there is illustrated in a block diagram, input queuing in accordance with an embodiment of the present invention. A control processor, for example, a control microprocessor 100 communicates with a modem, for example, a broadband modem 104 through an interface, for example, a processor interface 102. A plurality of processor queues 106, which can be implemented in software within the processor 100, use processor queue selection entities 108 to transmit data over the processor interface 102 to modem queues 112 in the modem 104. Although a plurality of processor queue selection entities is illustrated in FIG. 1, it is also contemplated that a single processor queue selection entity may work as well to process the processor queues 106. A plurality of the modem queues 112 within the modem 104 is serialised into a single data stream 118 through a queue server, for example modem queue server 116 of the present example relating to data transmission. By “queue server”, we include hardware or a combination of hardware and software for servicing one or more queues. Another example of a queue server is modem queue server 216 relating to the transmission of data, discussed below. The modem queue server 116 is controlled by a slot processor 110 in the control microprocessor 100. Slot processor 8 is responsible for the time plan of the TDM/TDMA transmission and is capable of handling both fixed time plan and burst transmissions.

Referring to FIG. 1, modem queue server 2 uses a timing controller 119 which controls the timing of transmission (and receipt) of data packets according to the time plan of slot processor 110. A timing reference 117 provides a time source for a timing controller 119. The timing controller 119 is programmed with knowledge of the format of the TDM stream slots and this information is maintained by the slot processor 110.

Time division multiplexing can be effected using continuous mode or burst mode. In continuous mode, each slot has the same size and format. By contrast, in burst mode, the slots may be different sizes and assigned to different users or terminals. The details of the slot are contained in a burst time plan.

The present invention is suitable for both continuous and burst mode. For example, in communications network between a hub and several terminals, a continuous forward link is used but a burst return link is used. Continuous mode can be treated as a special (simple) case of burst mode in which the interburst time is 0.

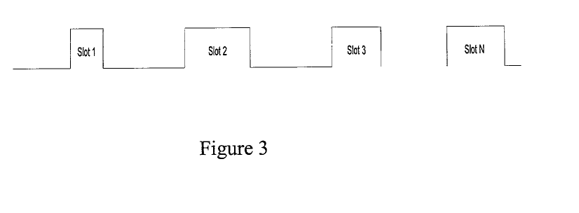

FIG. 3 shows a burst mode data stream consisting of a collection of sequential slots (numbered 1 to N) containing data elements. The data elements carried within a slot may be of the same type or of a different type than the data within another slot. The slots themselves may be of the same or differing sizes. In the case of a burst time plan, the correlation between data element type and slot is carried in a burst time plan table (not shown) in the slot processor 110. The slot processor 110 uses this information to program the modem queue server 116 and the timing controller 119.

Data from a higher layer application (i.e. data from any layer above the MAC layer, in which the invention resides) is fed into the appropriate processor queue 106. The processor queue selection entity 108 waits for space to become available in the corresponding modem queue 112. When space is available, the processor queue selection entity 108 uses queue priority information to select a data element from one of the processor queues 106 and passes it to the corresponding modem queue 112. The modem queue server 116 waits on a notification from the timing controller 119. This event signals that queues are to be accessed to create a single data element which is to be inserted into the next upcoming transmission slot. The data element could be created by reading a programmed amount of data from a single modem queue 112 or by reading a programmed amount of data from several modem queues 112 in a serial fashion.

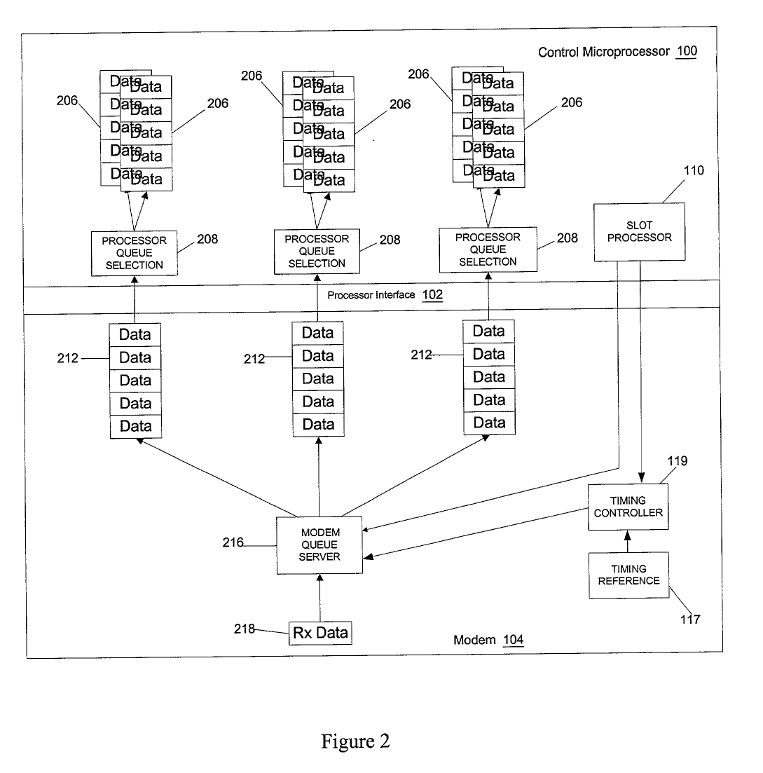

Referring to FIG. 2, there is illustrated in a block diagram, output queuing in accordance with an embodiment of the present invention. A control processor, for example, a control microprocessor 100 communicates with a modem, for example, a broadband modem 204 through a processor interface 202. A plurality of processor queues 206, which can be implemented in software within the processor 100, receive data from processor queue selection entities 208 over the processor interface 102 from modem queues 212 in the modem 104. A received data stream 218 is broken apart by a modem queue server 216 and fed into a plurality of modem queues 212 within the modem 104. The modem queue server 216 is controlled via a timing controller 119 in the modem and via a slot processor 110 in the processor. A timing reference 117 within the modem 104 provides a time source for a timing controller 119.

Data in data stream 218 received on each time slot is fed into the modem queue server 216. The modem queue server 216 is programmed to write data into one or more selected modem queues 212 upon notification from the timing controller 119 within the modem queue server 216. As in the transmission case, the timing controller 119 and the modem queue server 216 are programmed by the slot processor 210 using information contained within the burst time plan. The modem queue server 216 notifies the corresponding processor queue selection entity 208 that data is available. The processor queue selection entity 208 retrieves and examines the data and deposits it an appropriate processor queue 206. A higher layer application can then retrieve the data from the processor queue 206.

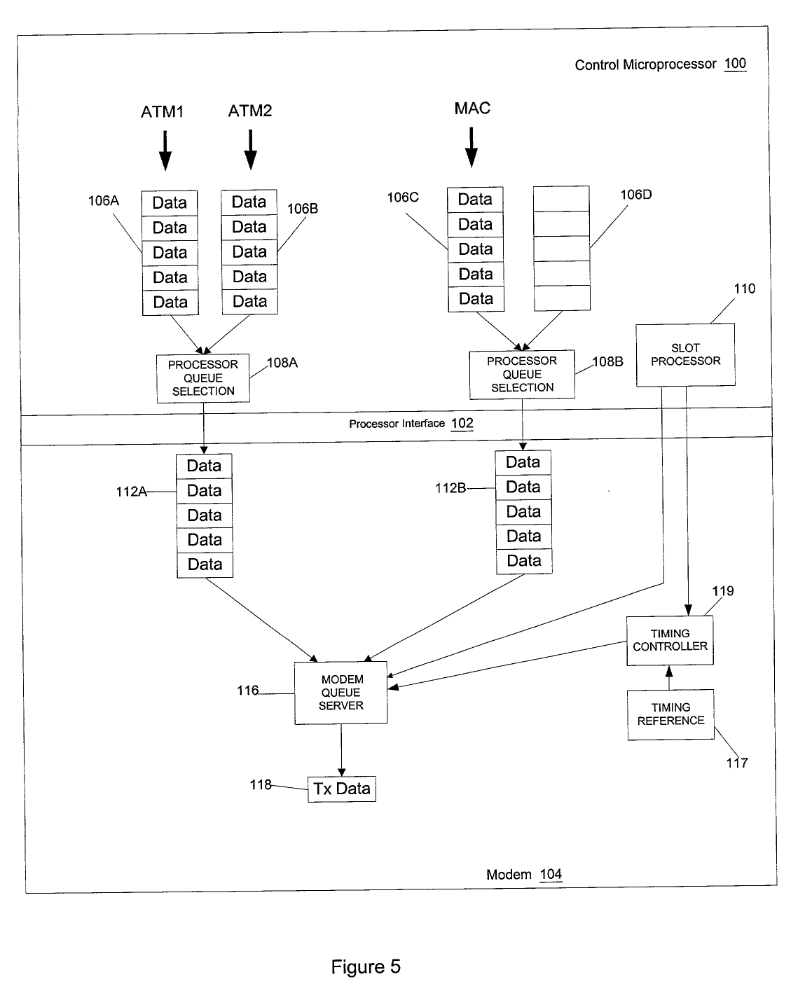

A specific example of queuing and transmission of data in accordance with the present invention is given in FIG. 5 in which there are three incoming data streams containing ATM traffic and MAC messages. ATM data from data streams ATM1 and ATM2 are queued in processor queues 106A and 106B respectively. Similarly, MAC message data is queued in processor queue 106C. Processor queue 106D is empty.

Processor queue selection entity 108A is associated with processor queues 106A and 106B. Processor queue selection entity 106B is associated with processor queues 106C and 106D. Processor queue selection entity 108A checks the quality of service parameters contained in the ATM cells in process queues 106A and 106B and determines their relative priorities. It uses this priority information to pull data from the processor queues 106A and 106B and adds the pulled data into the modem queue 112A. In our example, the ATM data in process queue 106A (corresponding to data stream ATM1) enjoys a higher priority than that of processor queue 106B.

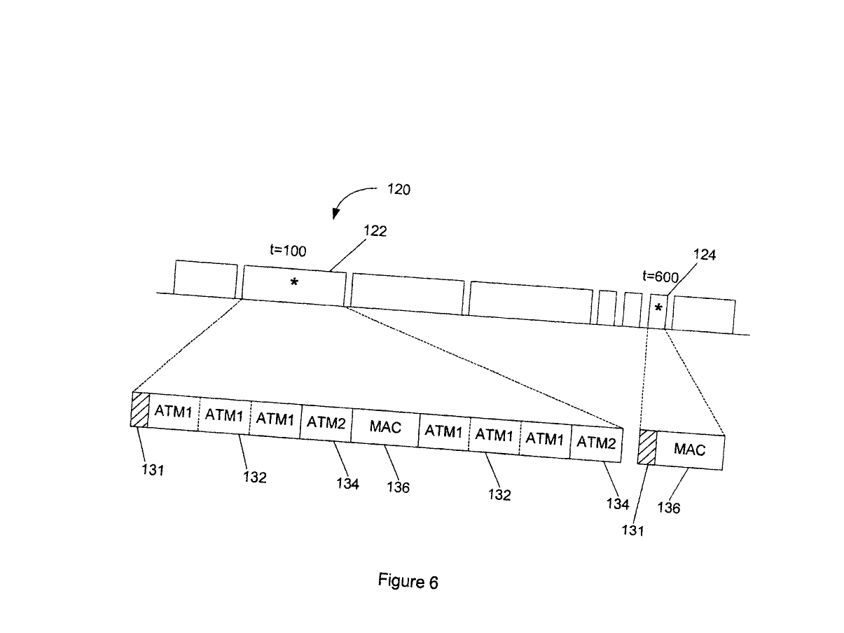

The burst time plan 120 is illustrated schematically in the upper portion of FIG. 6. At time t=100, a first time slot 122 is scheduled for transmission. Similarly, at time t=600 a second time slot 124 is scheduled for transmission. Note that according to the present invention, the slot processor 110, which is part of the control processor 100 and has poor timing resolution, is not concerned about the exact timing of the transmission. The modem queue server 116 need only ensure that the data for slot 122 is available to the modem 104 at t=100. The timing controller 119, which has good timing resolution, is responsible for exact timing of the transmission. Specifically, at some time close to, but before t=100, the modem queue server 116 pulls data from modem queue 112A based on data from slot processor 110. The modem queue server 116A then actually sends the data based on the timing of the timing controller 119.

The modem queue server 116 determines the data for slot 122 by examining the modem queues 112A and 112B. In the present example, the data for slot 122 consists of data from ATM1, ATM2 and MAC data streams. Specifically, as illustrated in the lower portion of FIG. 6, slot 122 contains a preamble 131 followed by three cells 132 from ATM1 followed by a cell 134 from ATM2 followed by a MAC message 136 followed again by three cells 132 from ATM1 and a cell 136 from ATM2. Note that the modem queue server 116 in the present example is based upon a simple round robin strategy, switching between modem queues 112A and 112B but a weighted fair queuing or other approaches are also possible Similarly, for slot 124, the modem queue server 116 pulls data from modem queue 112B before t=600 and transmits at t=600. Note that slot 124 is smaller than slot 122. After the preamble 131, there is a MAC message 136 but no data from modem queue 112A.

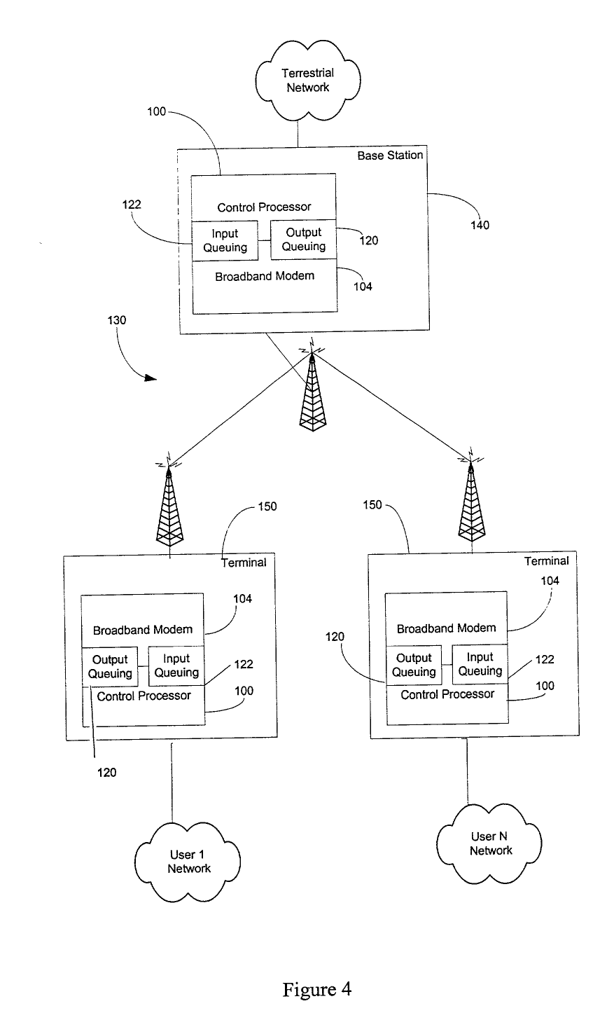

An example of the use of the invention in the context of a system is shown in FIG. 4. A broadband wireless network 130 using a TDM forward channel and a TDMA return channel is depicted. This system consists of a base station control unit 140 and multiple customer terminals 150. Within the base station 140 there exists the control processor 100 and broadband modem 104. Both input queuing 122 and output queuing 120 are used to provide the data path communication between the modem 104 and the control processor 100. Similarly, within each terminal 142 there exists a control processor 100 and modem 104. Again both input queuing 122 and output queuing 120 are used to provide the data path communication required between the modem 104 and the control processor 100.

According to an alternate embodiment of the present invention, the time division multiple access data transfer apparatus has a plurality of programmable modem idle queues operatively connected to the modem queue selection entity wherein the idle queues provide data to the queue selection entity when the associated modem queues are empty.

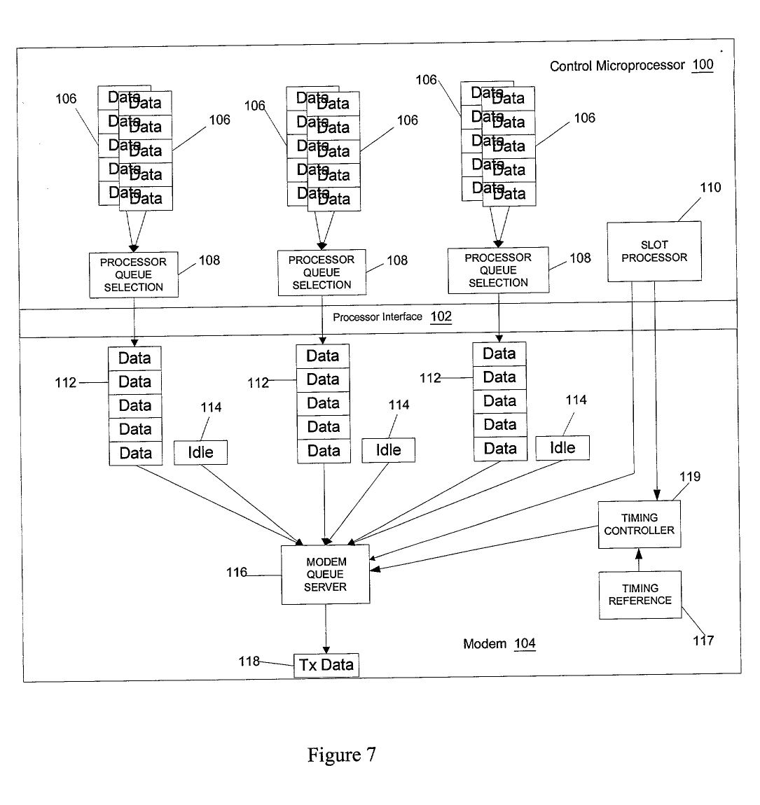

Referring to FIG. 7, each modem queue 112 has an idle cell queue 114 associated with it that is also input to the modem queue server 116. Idle queues 114 associated with each modem queue 112, have idle data which is accessed when a particular modem queue 112 is empty and data is to be read from it. The idle data generated for each queue is configurable. The idle data can be discarded on the receiving side at the appropriate layer. For example, the idle cell might be a standard ATM idle cell having a special header and then consist of all zeros in the data.

The above-described embodiments of the invention are intended to be examples of the present invention. Alterations, modifications and variations may be effected the particular embodiments by those of skill in the art, without departing from the scope of the invention which is defined solely by the claims appended hereto.

We claim:

1. A system for queuing data for transmission by a modem comprising:
first queues for queuing received data from a plurality of data streams;
at least one queue selection entity for selecting data from the first queues;
second queues for queuing data from the at least one queue selection entity; and
a queue server for assembling data from the second queues for transmission by the modem.

2. The system of claim 1 wherein the first queues comprise a plurality of groups of data queues and wherein the at least one queue selection entity comprises a plurality of queue selection entities, each queue selection entity corresponding to one group of data queues and wherein each queue selection entity selects data from the corresponding group of data queues.

3. The system of claim 1 wherein the first queues are input queues for receiving data within a control microprocessor.

4. The system of claim 1 wherein the second queues are modem queues.

5. The system of claim 3 wherein the queue server is a modem queue server.

6. The system of claim 1 wherein the assembled data is assembled into packets suitable for transmission using time division multiplexing.

7. The system of claim 1 further comprising an idle queue associated with at least one modem queue for providing idle data when the modem queue is empty.

8. The system of claim 5 wherein the idle data of the idle queue is configurable.

9. The system of claim 1 wherein the plurality of data streams contain data have a common format.

10. The system of claim 1 wherein the format of the data in at least two of the plurality of data streams are different from each other.

11. The system of claim 10 wherein the assembled data includes data from each of the at least two different data formats.

12. The system of claim 10 wherein the assembled data is for transmission in a time division multiplexing time slot.

13. The system of claim 1 further comprising a slot processor for providing timing information to the queue server.

14. The system of claim 13 wherein the slot processor includes a burst time plan table from which the timing information is derived.

15. The system of claim 1 further comprising a timing controller for controlling the transmission of the data from the queue server and a timing reference providing a time source to the timing controller.

16. A system for queuing data received by a modem comprising:
a queue server for disassembling data received by the modem;
a plurality of first queues for queuing the disassembled data;
a plurality of second queues; and
at least one queue selection entity for receiving data from the first queues and queuing the data to the second queues.

17. The system of claim 16 wherein the plurality of second queues comprises a plurality of groups of second queues and wherein the at least one queue selection entity comprises a plurality of queue selection entities corresponding to the number of groups of second queues and wherein each queue selection entity queues data to the queues of a corresponding group of second queues.

18. A method of queuing data for transmission by a modem comprising:
selecting data from each of a plurality of group of first queues;
queuing the selected data into a plurality of second queues;
selecting data from the data queued in the second queues; and
assembling the selected data element from the second queues for transmission by the modem.

19. The method of claim 18 further comprising the preliminary step of queuing data in the plurality of groups of first queues.

20. A method of queuing data received in a modem comprising:
disassembling the received data;
queuing the disassembled data to a plurality of first queues;
retrieving data from the plurality of first queues; and
queuing the retrieved data to a plurality of groups of second queues.
